(19) United States
(12) Patent Application Publication
(10) Pub. No.: US 2020/0001377 A1
(43) Pub. Date: Jan. 2, 2020

(54) DRILL BIT WITH CHAMFERING FUNCTION

(71) Applicant: SHUN-SHIH HUANG, Taichung City (TW)

(72) Inventor: SHUN-SHIH HUANG, Taichung City (TW)

(21) Appl. No.: 16/020,608

(22) Filed: Jun. 27, 2018

(51) Int. Cl. B23B 51/10; B23B 51/02; B23B 51/08

(52) U.S. Cl. CPC B23B 51/108; B23B 51/02; B23B 2251/204; B23B 51/102; B23B 51/08

(57) ABSTRACT

A drill bit with chamfering function has a body, a chamfering blade, an abutting rod, an elastic element, an adjusting element, and a drill bit. The body is a hollow tube, and has an internal space, a blade opening, a pivot segment, and a connecting end. The chamfering blade is pivotally connected to the body, selectively extends out of the blade opening, and has a blade portion, a blade pivot portion, and an abutting portion. The abutting rod is disposed in the internal space and abuts against the abutting portion. The elastic element is disposed in the internal space and is compressed between the abutting rod and the adjusting element. The adjusting element is disposed in the internal space for adjusting an amount of compression of the elastic element. The drill bit is securely connected to the connecting end of the body.

### BACKGROUND OF THE INVENTION

### 1. Field of the Invention

The present invention relates to a drill bit, and more particular to a drill bit with a chamfering function that may drill a through hole and extend through the through hole by rotation and contraction of a chamfering blade of the drill bit to chamfer two ends of the through hole.

### 2. Description of Related Art

In general, when a metal workpiece is drilled to form a through hole, sharp burrs or burrs are generated at two ends of the through hole. Usually, a chamfering tool is used to cut the burrs to provide a chamfering effect.

However, such a machining method requires the metal workpieces to be clamped on different machine tables for drilling and chamfering respectively, which makes the machining process time-consuming, and an outer diameter of a chamfering tool needs to be larger than that of the metal workpiece. Then, the chamfering effect can be achieved. Therefore, when the chamfering tool and the metal workpiece are clamped on the machine tool for machining, the chamfering tool can only cut the burrs on an upper end of the through hole of the metal workpiece and cannot extend through the through hole to cut the burns on a lower end of the through hole. That is, after the chamfering tool cutting the burns on the upper end of the through hole of the metal workpiece, and then the metal workpiece is turned and re-clamped, so that the burns on the lower end of the through hole can be chamfered by the chamfering tool. Then, the angular processing procedures are complicated and time-consuming, and the production efficiency is naturally low.

In addition, when the shape of the metal workpiece is special or irregular, it will also increase the difficulty of chamfering, and then extend the processing time, or even unable to complete the chamfering action. With reference to FIG. 11, a metal workpiece 91 is U-shaped, after the metal workpiece 91 is drilled to form two through holes 92, a chamfering tool 93 can cut only two outer burrs 921 due to the limited size of the U-shaped space, and cannot to chamfer two inner burns 922 of the through holes 92.

To overcome the shortcomings, the present invention provides a drill bit with a chamfering function to mitigate or obviate the aforementioned problems.

### SUMMARY OF THE INVENTION

The main objective of the present invention is to provide a drill bit with a chamfering function that may drill a through hole and extend through the through hole by rotation and contraction of a chamfering blade of the drill bit to chamfer two ends of the through hole.

The drill bit with a chamfering function in accordance with the present invention has a body, a chamfering blade, an abutting rod, an elastic element, an adjusting element, and a drill bit. The body is a hollow tube, and has an internal space, a blade opening, a pivot segment, and a connecting end. The chamfering blade is pivotally connected to the body, selectively extends out of the blade opening, and has a blade portion, a blade pivot portion, and an abutting portion. The abutting rod is disposed in the internal space and abuts against the abutting portion. The elastic element is disposed in the internal space and is compressed between the abutting rod and the adjusting element. The adjusting element is disposed in the internal space for adjusting a amount of compression of the elastic element. The drill bit is securely connected to the connecting end of the body.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a drill bit with chamfering function in accordance with the present invention;

FIG. 2 is a perspective view of the drill bit with chamfering function in FIG. 1;

FIG. 3 is an operational side view in partial section of the drill bit with chamfering function in FIG. 1, before drilling a through hole;

FIG. 4 is an operational side view in partial section of the drill bit with chamfering function in FIG. 1, drilling a through hole;

FIG. 5 is an operational side view in partial section of the drill bit with chamfering function in FIG. 1, cutting an upper end of the through hole;

FIG. 6 is an operational side view in partial section of the drill bit with chamfering function in FIG. 1, after cutting the upper end of the through hole;

FIG. 7 is an operational side view in partial section of the drill bit with chamfering function in FIG. 1, extending a lower end of the through hole after cutting the upper end of the through hole;

FIG. 8 is an operational side view in partial section of the drill bit with chamfering function in FIG. 1, cutting the lower end of the through hole;

FIG. 9 is an operational side view in partial section of the drill bit with chamfering function in FIG. 1, after cutting the upper end and the lower end of the through hole;

FIG. 10 is a side view in partial section of a second embodiment of a drill bit with chamfering function in accordance with the present invention; and

FIG. 11 is an operational side view of a conventional chamfering tool in accordance with the prior art, chamfered a metal workpiece.

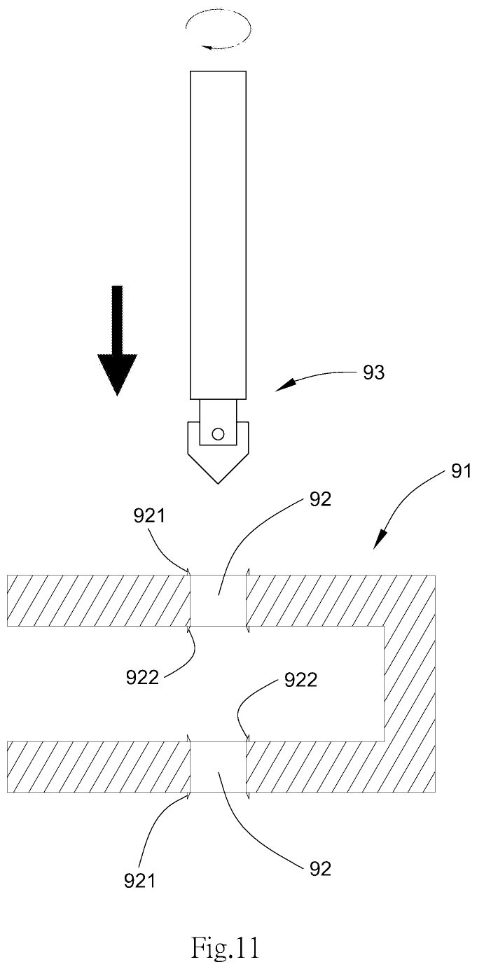

### DETAILED DESCRIPTION OF THE PREFERRED EMBODIMENT

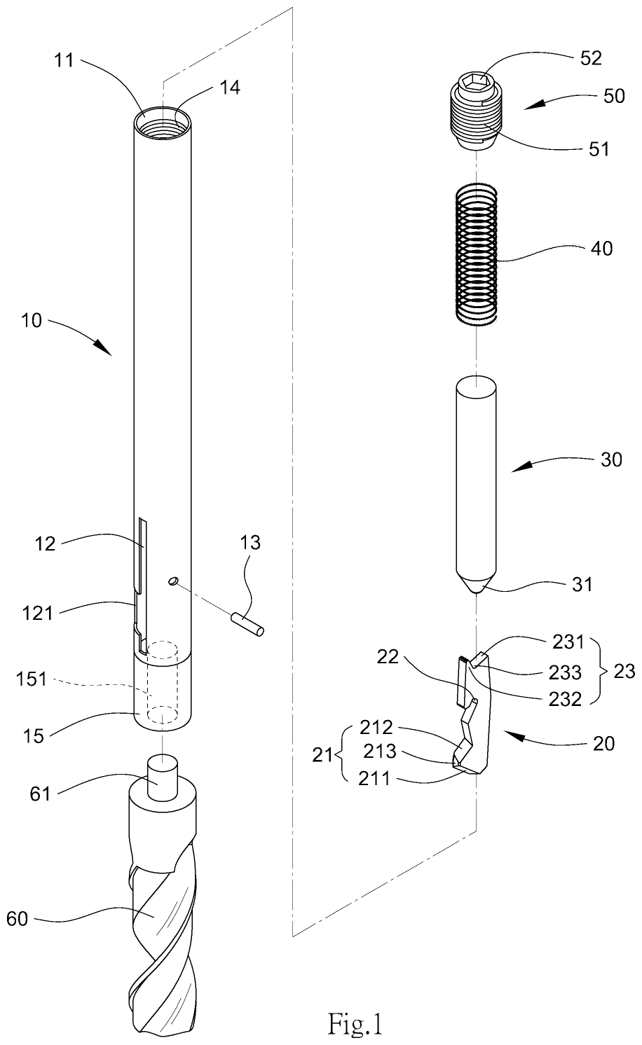

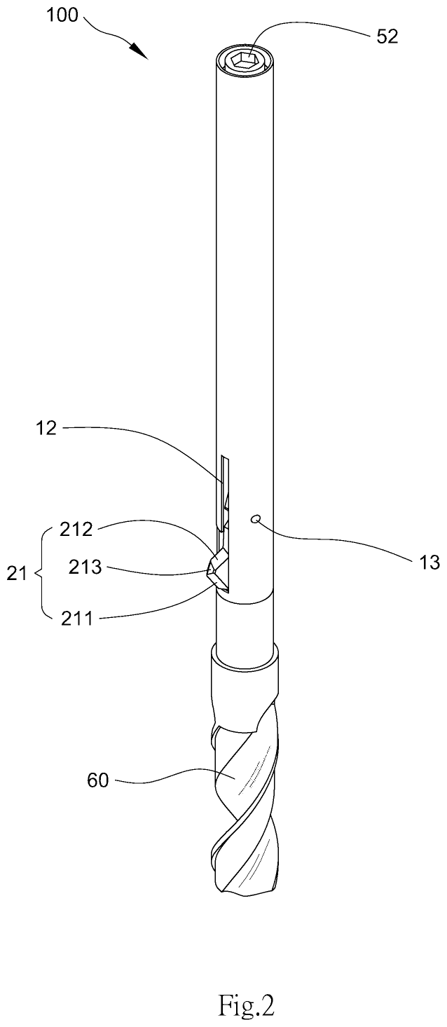

With reference to FIGS. 1 and 2, a first embodiment of a drill bit with chamfering function 100 in accordance with the present invention has a body 10, a chamfering blade 20, an abutting rod 30, an elastic element 40, an adjusting element 50, and a drill bit 60.

The body 10 is a hollow tube, and has a bottom, an external surface, an internal space 11, a blade opening 12, a pivot segment 13, and a connecting end 15. The internal space 11 is formed in the body 10. The blade opening 12 is formed through the external surface of the body 10 adjacent to the bottom of the body 10, and communicates with the internal space 11. The pivot segment 13 is disposed on the external surface of the body 10 adjacent to the blade opening 12, and extends through the internal space 11. The connecting end 15 of the body 10 is disposed on the bottom of the body 10.

The chamfering blade 20 is pivotally connected to the body 10 in the internal space 11, selectively extends out of the blade opening 12 of the body 10, and has a front end, a rear end, a blade portion 21, a blade pivot portion 22, and an abutting portion 23. The front end of the chamfering blade 20 selectively extends out of the blade opening 12 of the body 10. The blade portion 21 is disposed on the front end of the chamfering blade 20, and has a first blade edge 211, a second blade edge 212, and a rounded portion 213. The first blade edge 211 is obliquely disposed on the front end of the chamfering blade 20. The second blade edge 212 is obliquely disposed on the chamfering blade 20 toward the first blade edge 211 to form an angle between the two blade edges 211, 212. The rounded portion 213 is arc spherical and is disposed on the chamfering blade 20 between the first blade edge 211 and the second blade edge 212.

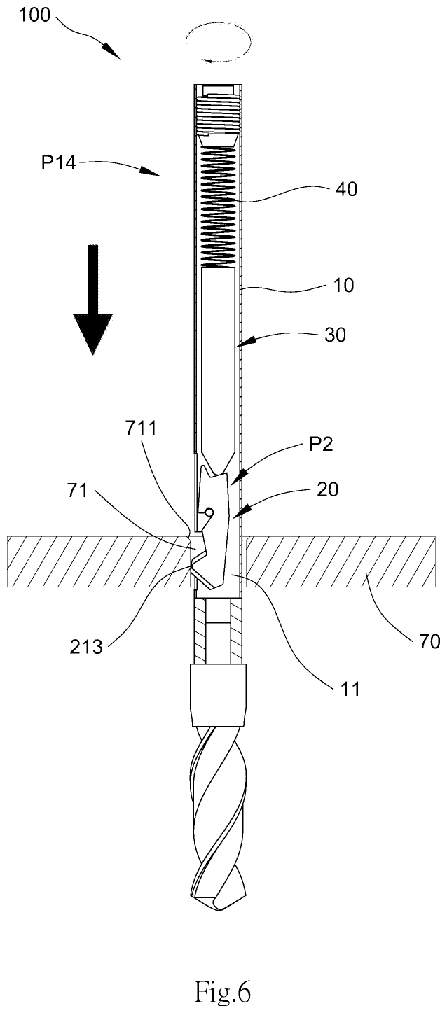

The blade pivot portion 22 is disposed on the chamfering blade 20 between the blade portion 21 and the rear end of the chamfering blade 20, is pivotally disposed on the pivot segment 13 to enable the chamfering blade 20 to rotate relative to the body 10 by the pivot segment 13 and having a cutting position P1 and a non-cutting position P2. When the chamfering blade 20 is located on the cutting position P1, the blade portion 21 extends out of the body 10 via the blade opening 12, and when the chamfering blade 20 is located on the non-cutting position P2, the blade portion 21 is disposed in the internal space 11 of the body 10 as shown in FIG. 6. The abutting portion 23 is disposed on the rear end of the chamfering blade 20 and is a V-shaped recess.

The abutting rod 30 is disposed in the internal space 11 of the body 10 via the top of the body 10, and has a front end and a pushing cone 31. The pushing cone 31 is disposed on the front end of the abutting rod 30 and abuts against the abutting portion 23 of the chamfering blade 20.

The elastic element 40 may be a spring that is generally available on the market, is disposed in the internal space 11 of the body 10, and is compressed between the abutting rod 30 and the adjusting element 50.

The adjusting element 50 is disposed in the internal space 11 of the body 10, is opposite to the connecting end 15, and is used for adjusting an amount of compression of the elastic element 40. With reference to FIG. 1, the body 10 further has an inner thread 14 disposed in the body 10 adjacent to the top of the body 10, and the adjusting element 50 has an outer thread 51 disposed on an external surface of the adjusting element 50 and screwed with the inner thread 14 of the body 10. Then, the adjusting element 50 can be disposed in the body 10 securely. Additionally, the adjusting element 50 has an adjusting portion 52 disposed on a distal end of the adjusting element 50 to adjust a relative position between the inner thread 14 and the outer thread 51. Furthermore, the adjusting portion 52 is a hexagonal groove and can be rotated by a hexagonal wrench. In this way, when the adjustment element 50 is rotated, the spiral motion can be converted into a linear motion, so that the adjustment element 50 moves linearly in the internal space 11 of the body 10 and is respectively moved toward or away the elastic element 40 according to the different rotating directions thereof. The amount of compression of the elastic element 40 is adjusted.

The drill bit 60 is securely connected to the body 10 at the connecting end 15 of the body 10, and has an outer diameter larger than an outer diameter of the body 10. In addition, the connecting end 15 of the body 10 has a connecting hole 151 axially formed through the connecting end 15 of the body 10 and communicating with the internal space 11 of the body 10. The drill bit 60 has a distal end facing the connecting end 15 of the body 10 and a connecting rod 61 formed on and axially protruding from the distal end of the drill bit 60 and mounted in the connecting hole 151 securely. Furthermore, the drill bit 60 can be formed with the body 10 as a single piece by means of sintering. Of course, in practice, the body 10 and the drill bit 60 can also be combined in other ways, such as welding.

In addition, since the connecting hole 151 is formed through the connecting end 15 to communicate with the internal space 11, when the drill bit 60 is broken and needs to replaced, it is only necessary to strike the connecting rod 61 in the connecting hole 151 via the internal space 11 to separate the broken drill bit 60 from the connecting end 15 of the body 10. Then, a connecting rod 61 of a new drill bit 60 is inserted into the connecting hole 151 of the connecting end 15 by means of sintering.

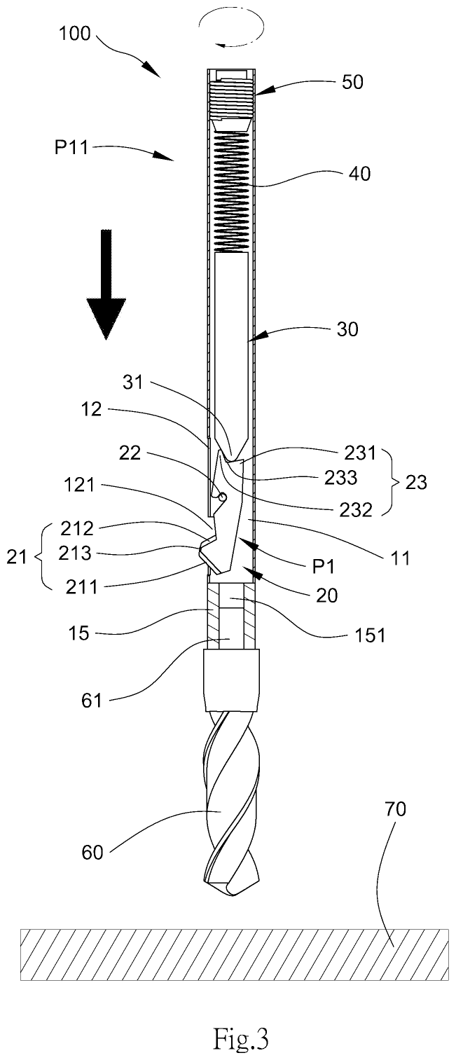

Therefore, with reference to FIG. 3, when no external force is used to press the chamfering blade 20, the adjusting element 50 adjusts the compression amount of the elastic element 40 so that the abutting rod 30 can press the chamfering blade 20 at the cutting position P1. When the rounded portion 213 of the chamfering blade 20 is pressed by a lateral pressure greater than the pressure of the elastic element 40, the chamfering blade 20 is rotated to the non-cutting position P2 as shown in FIG. 6.

In the first embodiment of the present invention, the pushing cone 31 has a conical shape, and the abutting portion 23 has a first abutting section 231, a second abutting section 232, and an abutting recess 233. The first abutting section 231 and the second abutting section 232 extend outwardly from the abutting recess 233 respectively, forming a V-shaped included angle, so that the pushing cone 31 is limited to in the V-shaped angle and is not easily detached. Furthermore, the interlocking relationship with the abutting portion 23 is maintained. Furthermore, the abutting portion 23 may also be an arc-shaped groove or a different type of design.

In more detail, the drill bit with chamfering function 100 of the present invention is used to drill a through hole and to chamfer two ends of the through hole. The outer diameters of the body 10 and the drill bit 60 may be different according to different needs to produce different diameters of through holes and to chamfer the through holes.

In operation, when a metal workpiece 70 needs to drill a through hole 71 and two ends of the through hole 71 need to be chamfered, the drill bit with chamfering function 100 is firstly moved to above the metal workpiece 70 and driven to rotate. With reference to FIG. 3, when the drill bit with chamfering function 100 is rotated and moved at a first position P11 above the metal workpiece 70, the abutting rod 30 is pressed by the elastic element 40 to push against the first abutting section 231 of the abutting portion 23, so that the chamfering blade 20 is located at the cutting position P1.

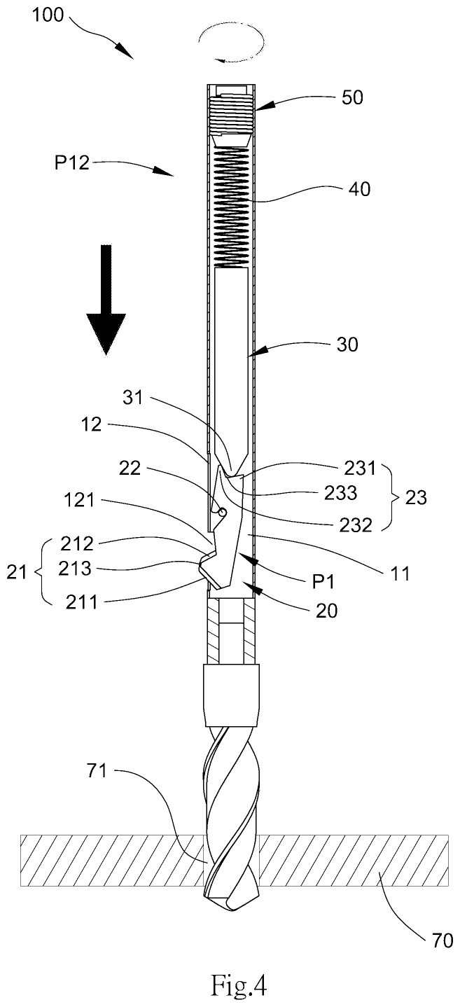

Then, with reference to FIG. 4, the drill bit with the chamfering function is moved downwards, so that the drill bit 60 drills the metal workpiece 70 to form a through hole 71. When the drill bit with chamfering function 100 is moved downwards from the first position P11 to a second position P12, the drill bit 60 is drilled through the metal workpiece 70 and the through hole 71 is created.

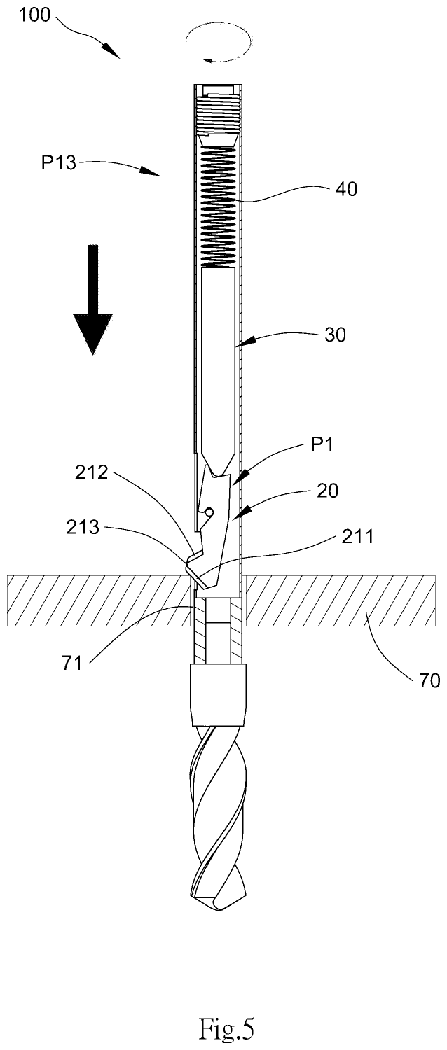

With reference to FIG. 5, after the through hole 71 is generated, the drill bit with chamfering functions 100 is continuously moved downward so that the first blade 211 contacts an upper end of the through hole 71 to perform cutting. When the drill bit with chamfering function 100 is moved downwards from the second position P12 to a third position P13, the first blade 211 is in contact with the upper end of the through hole 71 to perform cutting. The drill bit with chamfering function 100 needs to be stopped slightly to ensure the integrity of the chamfer. In design, one side of the blade opening 12 may be provided with a row of cutting holes 121 to achieve the effect of cutting in the cutting process.

With reference to FIG. 6, after chamfering the upper end of the perforation 71 completely, the drill bit with the chamfering function 100 is continuously moved downward. At this time, the chamfering blade 20 is limited by a aperture of the inner wall surface of the through hole 71. The chamfering blade 20 is gradually rotated and retracted to the non-cutting position P2. When an upper chamfering 711 on the upper end of the through hole 71 is completed, the drill bit with chamfering function 100 is continuously moved down to a fourth position P14. In the fourth position P14, at this time, the rounded portion 213 is circular arc-shaped and is restricted by the inner wall surface of the through hole 71 and is retracted from the body 10 into the internal space 11 of the body 10 (circular spherical design can protect the inner surface of the perforation 71 from damaged), and the chamfering blade 20 is rotated to the non-cutting position P2 (the first abutting section 231 pushes against the pushing cone 31 to move slightly upward).

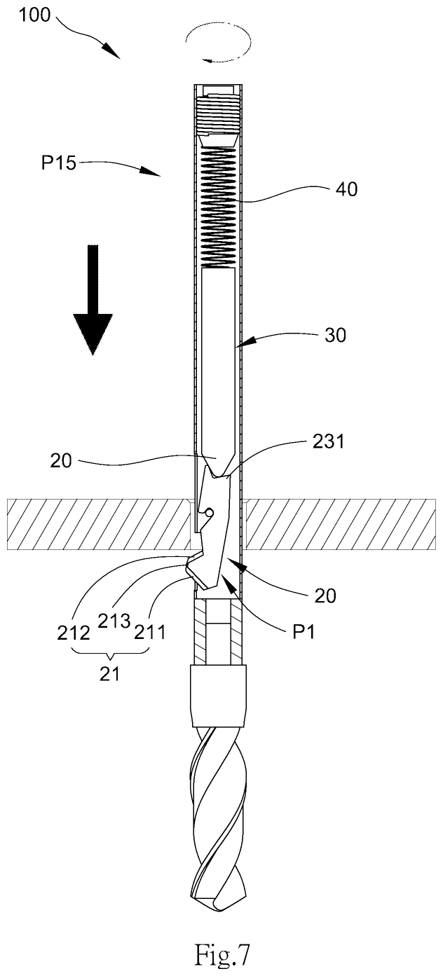

Then, after operating the drill bit with chamfering function 100 to move downward and passing the blade portion 21 of the chamfering blade 20 through the lower end of the through hole 71, the chamfering blade 20 returns to the cutting position P1. With reference to FIG. 7, when the drill bit with chamfering function 100 is moved down from the fourth position P14 to a fifth position P15, the chamfering blade 20 is no longer limited by the inner wall surface of the through hole 71. The abutting rod 30 is pressed by the elastic element 40 to push against the first abutting section 231, so that the chamfering blade 20 is rotated to return to the cutting position P1.

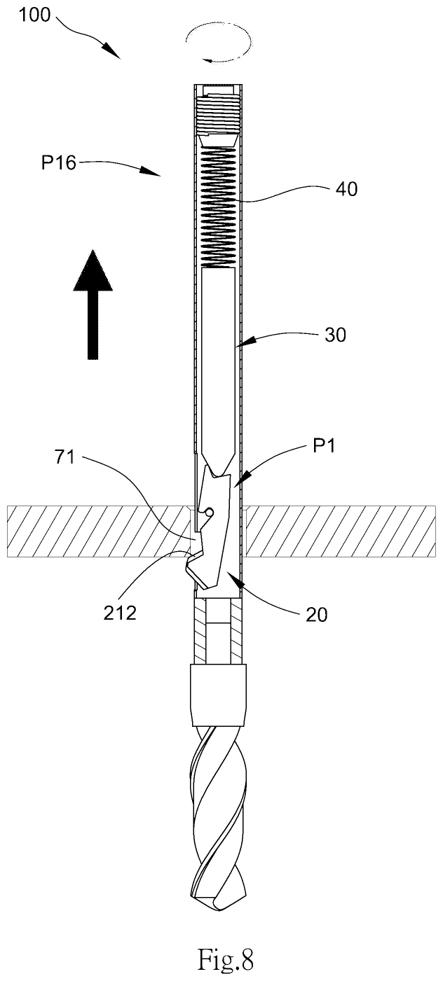

After the chamfering blade 20 is returned to the cutting position P1, the drill bit with the chamfering function 100 is operated to move upward, and the second blade 212 is contacted with the lower end of the through hole 71 to perform cutting as shown in FIG. 8. When the drill bit with chamfering function 100 is moved upwards from the fifth position P15 to a sixth position P16, the second blade edge 212 is in contact with the lower end of the through hole 71 for cutting. At this time, the drill bit structure with chamfering function 100 needs to be stopped slightly to ensure the completeness of the chamfering.

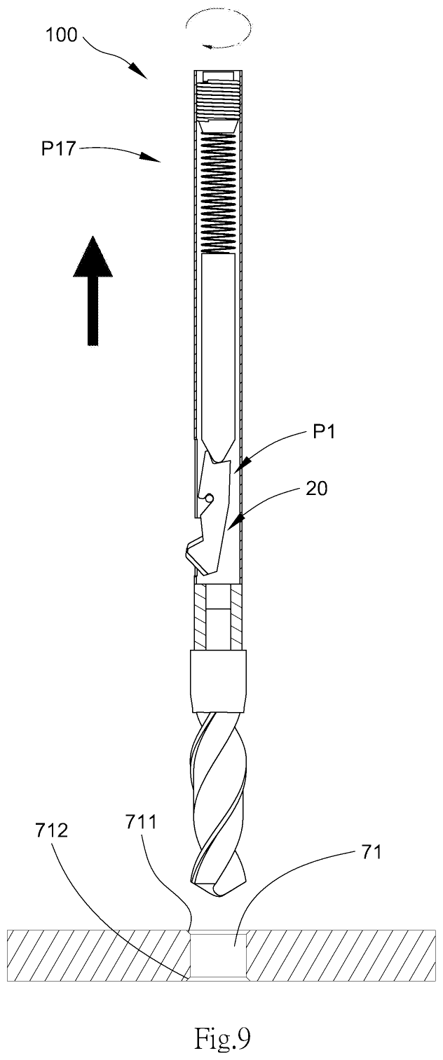

Finally, after chamfering the lower end of the through hole 71 completely, the drill bit with chamfering function 100 is continuously moved upward to exit the through hole 71 as shown in FIG. 9. When the lower chamfer 712 at the lower end of the through hole 71 is completed, the drill bit with chamfering function 100 is continuously moved upward to a seventh position P17 to exit the through hole 71. During the withdrawal, when the blade portion 21 passes through the inner wall surface of the through hole 71, the chamfering blade 20 is also gradually rotated and retracted to the non-cutting position P2. After the chamfering blade 20 is passed the upper end of the through hole 71, the chamfering blade 20 is returned to the cutting position P1.

Consequently, the drill bit with chamfering function 100 of the present invention is the same as the general cutting tool. It needs to be fixed on a cutter sleeve first, and then the cutter sleeve is clamped on a spindle of a machine tool. The drill bit with chamfering function 100 of the present invention is driven by the machine tool to rotate, and the metal workpiece 70 needs to be fixed on a clamping table of the machine tool. The clamping and fixing method of the machine tool is a common technology, and therefore omitted in the drawings of the present invention.

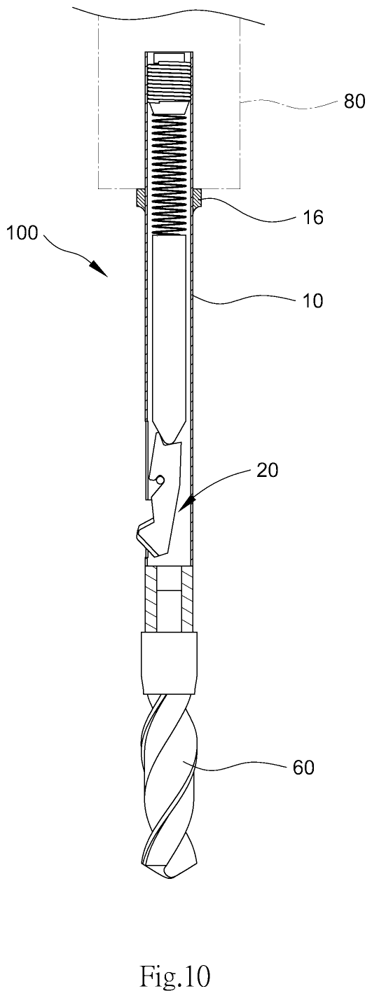

With reference to FIG. 10, a second embodiment of a drill bit with chamfering function in accordance with the present invention, the body 10 further has a limiting portion 16 annularly formed on an outer periphery of the body 10 for limiting a relative fixing position of the body 10 and the cutter sleeve, so as to prevent the drill bit 60 from being squeezed during drilling. As a result, the fixed position of the body 10 is axially slid, resulting in an inability to accurately chamfer. When the creation is processed, the body 10 is fixed on a sleeve 80 (i.e. the aforementioned cutter sleeve), and the limiting portion 16 can abut a bottom surface of the sleeve 80. When the drill bit 60 is drilled the workpiece and squeezed, the body 10 is in contact with the bottom surface of the sleeve 80 by the limiting portion 16 without axial sliding, thereby ensuring the accuracy of the chamfering. Of course, the limit portion 16 can also be changed according to the user's needs in the change of the appearance. For example, the limit portion 16 is a plurality of bumps symmetrically arranged around the outer periphery of the body 10.

In addition, the present invention takes metal workpieces as an example because it is easier for burrs to occur after metal workpieces are drilled. When the workpiece is made of other materials, the through holes also can be chamfered bi-directionally by the drill bit with chamfering function of the present invention.

In summary, the present invention not only can directly perform chamfering after drilling, but also utilizes the characteristics of the double-blade and shrinkable edge of the chamfering blade 20, and can work on the workpiece without turning the workpiece. The chamfering at both ends effectively reduces the time for workpiece clamping correction, thereby improving product productivity.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A drill bit with chamfering function comprising:
a body being a hollow tube, and having
a bottom;
an external surface;
an internal space formed in the body;
a blade opening formed through the external surface of the body adjacent to the bottom of the body, and communicating with the internal space;
a pivot segment disposed on the external surface of the body adjacent to the blade opening, and extending through the internal space; and
a connecting end disposed on the bottom of the body;
a chamfering blade pivotally connected to the body in the internal space, selectively extending out of the blade opening of the body, and having
a front end selectively extending out of the blade opening of the body;
a rear end;
a blade portion disposed on the front end of the chamfering blade, and having
a first blade edge obliquely disposed on the front end of the chamfering blade;
a second blade edge obliquely disposed on the chamfering blade toward the first blade edge; and
a rounded portion disposed on the chamfering blade between the first blade edge and the second blade edge;
a blade pivot portion disposed on the chamfering blade between the blade portion and the rear end of the chamfering blade, pivotally disposed on the pivot segment to enable the chamfering blade to rotate relative to the body by the pivot segment and having a cutting position and a non-cutting position; and
an abutting portion disposed on the rear end of the chamfering blade and being a recess;
wherein the chamfering blade is located on the cutting position, the blade portion extends out of the body via the blade opening, and the chamfering blade is located on the non-cutting position, the blade portion is disposed in the internal space of the body;
a pushing rod disposed in the internal space of the body via the top of the body, and having
a front end; and
a pushing cone disposed on the front end of the abutting rod and abutting against the abutting portion of the chamfering blade;
an elastic element disposed in the internal space of the body;
an adjusting element disposed in the internal space of the body, being opposite to the connecting end, hold the elastic element between the abutting rod and the adjusting element for adjusting a amount of compression of the elastic element; and
a drill bit securely connected to the body at the connecting end of the body, and having an outer diameter larger than an outer diameter of the body;
wherein no external force is pressed the chamfering blade, the adjusting element adjusts the compression amount of the elastic element so that the abutting rod press the chamfering blade at the cutting position, and the rounded portion of the chamfering blade is pressed by a lateral pressure greater than the pressure of the elastic element, the chamfering blade is rotated to the non-cutting position.

2. The drill bit with chamfering function as claimed in claim 1, wherein the body has a row of cutting holes disposed on a side of the blade opening.

3. The drill bit with chamfering function as claimed in claim 1, wherein
the rounded portion is arc spherical; and
the second blade edge is obliquely disposed on the chamfering blade toward the first blade edge to form an angle between the two blade edges; and
an end of the angle between the two blade edges is the rounded portion.

4. The drill bit with chamfering function as claimed in claim 1, wherein the abutting portion has a first abutting section, a second abutting section, and an abutting recess, the first abutting section 231 and the second abutting section extend outwardly from the abutting recess respectively to form a V-shaped angle.

5. The drill bit with chamfering function as claimed in claim 1, wherein the elastic element is a spring.

6. The drill bit with chamfering function as claimed in claim 1, wherein
the body has an inner thread disposed in the body adjacent to a top of the body; and
the adjusting element has an outer thread disposed on an external surface of the adjusting element and screwed with the inner thread of the body; and
the adjusting element is used to adjust a relative position between the outer thread and the inner thread.

7. The drill bit with chamfering function as claimed in claim 1, wherein
the connecting end of the body has a connecting hole axially formed through the connecting end of the body and communicating with the internal space of the body; and
the drill bit has a distal end facing the connecting end of the body and a connecting rod formed on and axially protruding from the distal end of the drill bit and mounted in the connecting hole securely.

8. The drill bit with chamfering function as claimed in claim 7, wherein the drill bit is formed with the body as a single piece by means of sintering.

9. The drill bit with chamfering function as claimed in claim 1, wherein the body has a limiting portion on an outer periphery of the body.

10. The drill bit with chamfering function as claimed in claim 9, wherein the limiting portion is annularly formed on the outer periphery of the body.
